(19) United States
(12) Patent Application Publication
(10) Pub. No.: US 2021/0387029 A1
(43) Pub. Date: Dec. 16, 2021

(54) Dual Clappet Mask

(71) Applicant: Todd Zhou, Potomac, MD (US)

(72) Inventor: Todd Zhou, Potomac, MD (US)

(21) Appl. No.: 17/461,635

(22) Filed: Aug. 30, 2021

(51) Int. Cl. A62B 18/10; A62B 18/02

(52) U.S. Cl. CPC A62B 18/10; A62B 18/025

(57) ABSTRACT

The Dual Clappet Mask is to protect people from inhaling harmful air around them. They inhale and exhale by the same mouth nipple connected to a dual clappet, and the two clappets are open/close automatically to fulfill the respiring.

Unlike filtering the inside air, the Dual Clappet Mask uses outside clean air via a soft tube, and in this way it would protect people very well from a small toxic, dusty and anoxic environment.

The Dual Clappet Mask is a mask that provides breath air to the mouth, instead of the nose, of a person to protect her or him from being hurt by polluted air. The person uses the same nipple in the mask both to inhale and exhale air by the clappets, which let air from outside or discharge gas away from the mask, referring FIG. 1. In this way the breathing air is separated thoroughly with the site environment the person is in. The Mask can be used inside or some rather closed place where people have to work in a dusty, toxic or anoxic environment.

### 1. BRIEF DESCRIPTION OF THE DRAWING

FIG. 1, Assembly: This is the front view of the Dual Clappet Mask showing all parts of it.

### 2. COMPOSITION

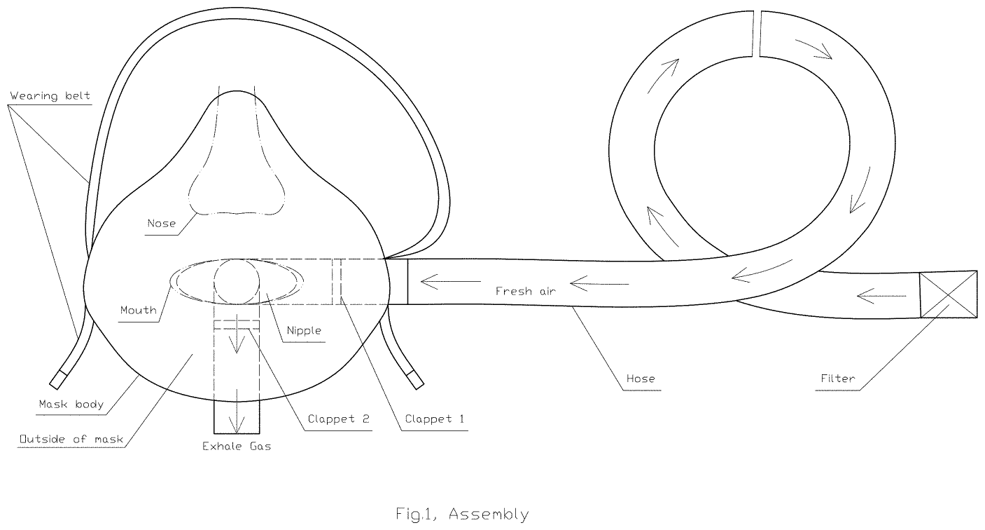

Inside the Mask there is a nipple in the middle, referring FIG. 1. The nipple is connected to the clappets and then is connected to a flexible tube on the side of the Mask. The other end of the tube is fitted with a filter and is put on a safe place outside free of any harmful gas.

### 3. USING OF THE DUAL CLAPPET MASK

Wearing the Mask, the protected person keeps the nipple in mouth and can breathe clean air. The air goes this way, referring FIG. 1:

When inhaling, clappet 1 is open and clappet 2 is closed. The air goes through the filter to the tube, and then passes clappet 1 and the nipple into mouth.

When exhaling, clappet 1 is closed and clappet 2 is open. The gas from mouth goes through clappet 2 to the outlet on the bottom of the Mask.

The nipple and the clappets are easily taken off and washable, so people can wash them before and after using. The material of the mask is soft and safe to people's mouth and face.

### 4. ADVANTAGES

1) Instead of using inside air, the Mask provide outside fresh air for person's inhale, so the inside polluted air cannot affect the person by respiratory passage, and the result is surely better than those of masks which rely on filtering/sterilizing the inside air.

2) The structure is less complicated than those masks with own air/oxygen unit, so as a result it would cost low when being produced in bulk.

1. A mask using the same mouth nipple for both inhaling and exhaling to prevent polluted air from harming people by breath, in a small dusty, toxic or anoxic environment

2. A dual clappet is applied in a mask to automatically control the passage of gas to the mask.
